(19) United States
(12) Patent Application Publication
(10) Pub. No.: US 2016/0124481 A1
(43) Pub. Date: May 5, 2016

(54) METHODS AND SYSTEMS FOR DETECTING UNDERVOLTING OF PROCESSING CORES

(71) Applicant: QUALCOMM Incorporated, San Diego, CA (US)

(72) Inventors: Phani Bhushan Avadhanam, San Diego, CA (US); Afshin Hosseinipour, San Diego, CA (US); Matthew Wagantall, Santee, CA (US); Mark Game, Durham, NC (US); Anup Wadia, Wake Forest, NC (US)

(21) Appl. No.: 14/529,762

(22) Filed: Oct. 31, 2014

(51) Int. Cl. G06F 1/28; G06F 1/30

(52) U.S. Cl. CPC G06F 1/28; G06F 1/305

(57) ABSTRACT

An example method for detecting undervolting of a core of a multi-core processing unit includes reading a value of an entry counter and a value of an exit counter. The value of the entry counter indicates that a core of the multi-core processing unit has begun executing a code section, and the value of the exit counter indicates that the core has completed executing the code section. The method also includes determining that the core was undervolted when: (i) the value of the entry counter is not the same as the value of the exit counter, and (ii) a core power resource does not satisfy a power resource threshold for the core.

### FIELD OF DISCLOSURE

The present disclosure generally relates to processors, and more particularly to detecting the undervolting of one or more processing cores.

### BACKGROUND

A multi-core processor typically includes a plurality of processing cores. When a core transitions from a powered-down state to a powered-up state, the other cores in the multi-core processing unit may perform actions to ensure that the transitioning core has sufficient voltage or current to operate properly. If the transitioning core enters the powered-up state unexpectedly, however, the other cores in the multi-core processing unit may be unable to perform those particular actions to ensure that the transitioning core has sufficient voltage or current to operate correctly. If these actions are not performed, the transitioning core may crash or fail to operate properly. Undervolting of a core occurs when the core has insufficient voltage or current to operate correctly.

### BRIEF SUMMARY

Methods, systems, and techniques for detecting undervolting of one or more cores of a multi-core processing unit are provided.

According to some embodiments, a method of detecting undervolting of one or more cores of a multi-core processing unit includes reading a value of an entry counter and a value of an exit counter. The value of the entry counter indicates that a core of the multi-core processing unit has begun executing a code section, and the value of the exit counter indicates that the core has completed executing the code section. The method also includes determining that the core was undervolted when: (i) the value of the entry counter is not the same as the value of the exit counter, and (ii) a core power resource does not satisfy a power resource threshold for the core.

According to some embodiments, a system for detecting undervolting of one or more cores of a multi-core processing unit includes a multi-core processing unit including a plurality of cores. A core of the multi-core processing unit executes one or more instructions and has an associated entry counter and exit counter. The system also includes an undervoltage detection module that reads a value of an entry counter and a value of an exit counter and determines that the core was undervolted when: (i) the value of the entry counter is not the same as the value of the exit counter, and (ii) a core power resource does not satisfy a power resource threshold for the core. The value of the entry counter indicates that a core of the multi-core processing unit has begun executing a code section, and the value of the exit counter indicates that the core has completed executing the code section.

According to some embodiments, a computer-readable medium has stored thereon computer-executable instructions for performing operations including: reading a value of an entry counter and a value of an exit counter, the value of the entry counter indicating that a core of the multi-core processing unit has begun executing a code section, and the value of the exit counter indicating that the core has completed executing the code section; and determining that the core was undervolted when: (i) the value of the entry counter is not the same as the value of the exit counter, and (ii) a core power resource does not satisfy a power resource threshold for the core.

### BRIEF DESCRIPTION OF THE DRAWINGS

The accompanying drawings, which form a part of the specification, illustrate embodiments of the disclosure and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for detecting undervolting of one or more cores of a multi-core processing unit, according to some embodiments.

FIG. 2 is a block diagram illustrating another system for detecting undervolting of one or more cores of a multi-core processing unit, according to some embodiments

FIG. 3 is a block diagram illustrating another system for detecting undervolting of one or more cores of a multi-core processing unit, according to some embodiments

FIG. 4 is a flowchart illustrating a method of detecting undervolting of one or more cores of a multi-core processing unit, according to some embodiments.

FIG. 5 is a flowchart illustrating another method of detecting undervolting of one or more cores of a multi-core processing unit, according to some embodiments.

FIG. 6 is a block diagram of a computer system suitable for implementing one or more embodiments of the present disclosure.

### DETAILED DESCRIPTION

I. Overview

II. Example System Architecture
A. Multi-core Processor and Power States
B. Power Resources

III. Detect Undervolting of One or More Cores
A. Crash Detection
B. Analyze the Crash to Determine Whether a Core was Undervolted
   1. Core Determined to Not Be Undervolted
   2. Core Determined to Be Undervolted
C. Analyze Reason for Core Entering the Powered-up State
   1. Determine Whether Spurious Interrupt Occurred
   2. Reason for Interrupt

IV. Example System Architectures

V. Example Methods

VI. Example Computing Device

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

### II. Example System Architecture

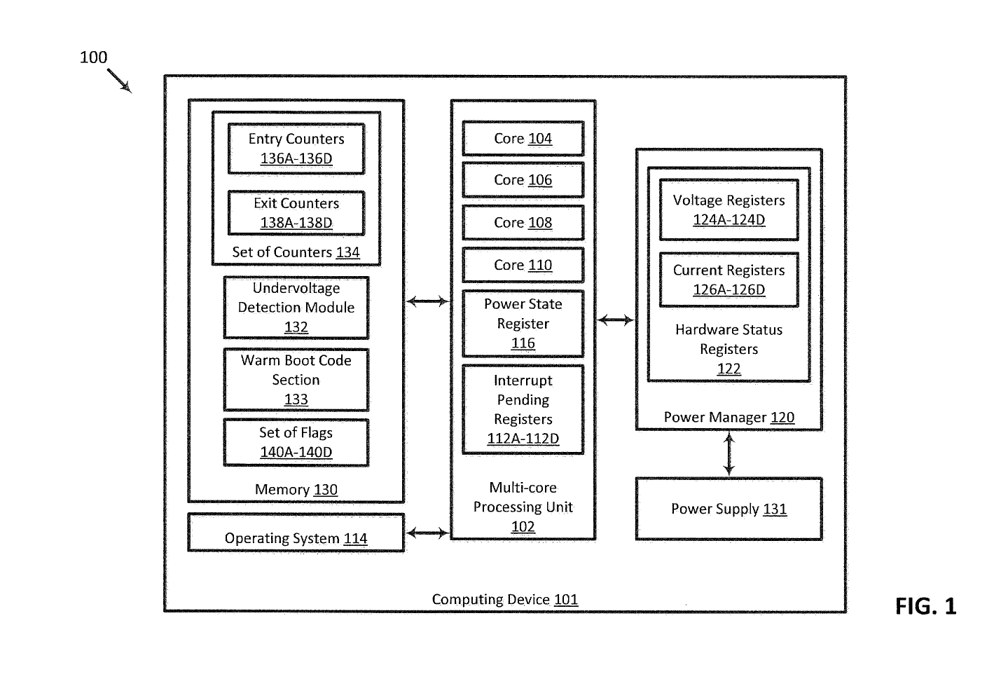

FIG. 1 is a block diagram illustrating a system 100 for detecting undervolting of one or more cores of a multi-core processing unit 102, according to some embodiments. FIG. 1 includes a computing device 101 including multi-core processing unit 102, which includes cores 104, 106, 108, and 110. In the present disclosure, the term “core” and “processor” may be used interchangeably, and each core may process one or more instructions.

### A. Multi-Core Processor and Power States

At least two cores of multi-core processing unit 102 may be cores in the same physical package or in different physical packages. Two processors may be coupled via a high-speed front side bus (FSB), and each processor may contain cores that share an L2 cache. Additionally, at least two cores of multi-core processing unit 102 may be homogenous cores that support the same instruction set architecture (ISA) or may be heterogeneous cores that support different ISAs. An advantage of having heterogeneous cores may be the ability to employ cores optimized for specific needs to an application.

Multi-core processing unit 102 is coupled to a power supply 130 via a power manager 120. Power supply 130 may be a battery that provides power to multi-core processing unit 102. Although power supply 130 is illustrated as being internal to computing device 101, it should also be understood that power supply 130 may be an external power supply. Power manager 120 may include a power management integrated circuit (PMIC) that controls the amount of voltage or current that is supplied to one or more cores of multi-core processing unit 102.

The cores of multi-core processing unit 102 may be in one of a plurality of power states. The plurality of power states may include a powered-up state and a powered-down state. In the powered-up state, a core is ready to execute instructions. In an example, a core in the powered-up state may be in a normal mode of operation in which all of the core's functionality is available and core logic and embedded random access memory (RAM) arrays associated with the core are clocked and powered-up. In another example, a core in the powered-up state may be in a standby mode in which most of the clocks of the core are disabled while the core is powered-up. The standby mode reduces the power drawn to the static leakage current.

In the powered-down state, a core is not ready to execute instructions. Rather, a core in the powered-down state enters the powered-up state in order to execute instructions. In an example, a core in the powered-down state may be in a dormant mode that maintains some of the core's state (e.g., instruction and data cache). In another example, a core in the powered-down state may be in a shutdown mode in which all the power domains in the core are shut down and the core's state is not maintained.

Power is the product of voltage times current. Processor power consumption is proportional to frequency and the square of supply voltage. The faster a core is running, the more current the core will draw and the higher the voltage requirement. Similarly, if a core requires a large voltage supply, the more power that is consumed by the core. Each of the cores of multi-core processing unit 102 may be separated into its own power domain that is individually supplied a voltage or current that is controlled by power manager 120. Accordingly, power manager 120 may control the voltage or current that is supplied to each core, and each core may be powered-up or powered-down individually. To consume less power, power manager 120 may vary the voltage or current supplied to a core such that the supplied amount is approximately the minimum amount of voltage or current that allows for the core to function correctly.

Various mechanisms may be used to reduce the power consumed by a core. For example, dynamic voltage scaling is a software technique that changes the supply voltage and frequency supplied to a core at appropriate times to optimize a combined consideration of performance and energy consumption. In an example, each core of multi-core processing unit 102 has an independent voltage and clock(s). Accordingly, each of these cores may be run at the most efficient power point or voltage and frequency depending on the type of workload being executed.

### B. Power Resources

Power manager 120 includes a set of hardware status registers 122 that provide an indication of power resources that are supplied to one or more cores of multi-core processing unit 102 by power supply 130 via power manager 120. Set of hardware status registers 122 includes voltage registers 124A-124D and current registers 126A-126D. Each core of multi-core processing unit 102 may have an associated voltage register and current register. A voltage register may store an indication of an amount of voltage being supplied to the core associated with the voltage register, and a current register may store an indication of an amount of current being supplied to the core associated with the current register. Each core may have a threshold voltage and a threshold current at which the core is supplied to operate correctly. For example, if power manager 120 does not supply core 104 with its threshold voltage or threshold current, core 104 may crash or misbehave. The threshold voltage and/or threshold current for two cores of multi-core processing unit 102 may be different or the same.

In an example, core 104 has an associated voltage register 124A and current register 126A. In this example, voltage register 124A may be read to determine the amount of voltage being supplied to core 104 (e.g., 5 volts), and current register 126A may be read to determine the amount of current being supplied to core 104 (e.g., 10 milliamps). Similarly, core 106 has an associated voltage register 124B and current register 126B. Voltage register 124B may be read to determine the amount of voltage being supplied to core 106, and current register 126B may be read to determine the amount of current being supplied to core 106. Similarly, core 108 has an associated voltage register 124C and current register 126C. Voltage register 124C may be read to determine the amount of voltage being supplied to core 108, and current register 126C may be read to determine the amount of current being supplied to core 108. Similarly, core 110 has an associated voltage register 124D and current register 126D. Voltage register 124D may be read to determine the amount of voltage being supplied to core 110, and current register 126D may be read to determine the amount of current being supplied to core 110.

The following description may describe core 104 as being the core that enters the powered-up state from the powered-down state. It should also be understood that this description applies to the other cores as well along with their associated counters, registers, or flags. If core 104 is in the powered-down state, one or more of the other cores of multi-core processing unit 102 may perform actions to ensure that power manager 120 is configured appropriately to support core 104 entering the powered-up state.

In an example, core 106 may detect that the system has reached a threshold workload and that another core should be powered-up. Core 106 may then perform actions to ensure that power manager 120 is configured appropriately to support core 104 entering the powered-up state. In an example, core 106 sends a signal to power manager 120 that causes power manager 120 to increase its supplied voltage to multi-core processing unit 102 such that a proportion of the increased voltage is supplied to core 104. In this example, prior to interrupting or triggering an event so that core 104 enters the powered-up state from the powered-down state, core 106 (or any of the other cores of multi-core processing unit 102) may send one or more commands to power manager 120 to enable more power supplies (e.g. voltage regulators), configure those supplies to provide sufficient electrical current for core 104 to be powered on, and/or configure those power supplies to output a voltage that will be sufficient to supply core 104. Core 106 may then send an interrupt to core 104 that causes core 104 to enter the powered-up state from the powered-down state. Core 104 may then wakeup and initiate execution of instructions.

### III. Detect Undervolting of One or More Cores

In some instances, the power resources may be configured incorrectly and do not support the additional core entering the powered-up state from the powered-down state. For example, core 104 may enter the powered-up state without any of the cores of multi-core processing unit 102 intending for core 104 to do so. If core 104 enters the powered-up state before one or more of the other cores has performed the actions to ensure that power manager 120 is configured appropriately to support core 104 entering the powered-up state, then core 104 may crash or misbehave because core 104 may not have the appropriate power resources to function correctly. This may occur if core 104 is woken up via a spurious interrupt. For example, a peripheral device attached to computing device 101 may send a spurious interrupt to core 104 that causes core 104 to enter the powered-up state from the powered-down state. The interrupt may be unexpected by the other cores of multi-core processing unit 102 and may have been sent, for example, from faulty hardware or an interrupt line that went temporarily high due to a glitch. As such, none of the cores may have performed the actions to ensure that power manager 120 is configured appropriately to support core 104 entering the powered-up state.

In another example, a core of multi-core processing unit 102 may send a spurious interrupt to core 104 at a time when core 104 should not receive an interrupt. For instance, core 106 may decide to not power up core 104 for a variety of reasons. Core 108, on the other hand, may think that core 104 is already in the powered-up state and send an interrupt or event to core 104. If core 104 enters the powered-up state based on the interrupt from core 108, core 104 may be undervolted because power manager 120 has not been configured appropriately to support core 104 entering the powered-up state. For example, the voltage supplied by power manager 120 may be below a voltage threshold for the core or the current supplied by power manager 120 may be below a current threshold for the core.

### A. Crash Detection

When a core crashes, it may be desirable to determine whether the core crashed because it was undervolted. If a core is undervolted, it will typically crash early on (e.g., within the first few instructions that the core is executing instructions). Memory 130 is coupled to multi-core processing unit 102 and includes an undervoltage detection module 132 that detects undervolting of one or more cores of multi-core processing unit 102. If undervoltage detection module 132 detects a timeout of one or more cores, undervoltage detection module 132 may perform actions to determine whether any of the cores of multi-core processing unit 102 was undervolted. A core may time out if it is no longer operating or processing data. In an example, core 104 times out if another core of multi-core processing unit 102 attempts to communicate with core 104 without receiving a response from core 104 after a threshold amount of time has elapsed. In this example, a core (e.g., core 106, 108, or 110) in multi-core processing unit 102 may execute undervoltage detection module 132 live.

Multi-core processing unit 102 includes a power state register 116 that indicates which of the cores of multi-core processing unit 102 are in the powered-up state. Additionally, memory 130 includes a warm boot code section 133 and a set of counters 134 including entry counters and exit counters. Each core of multi-core processing unit 102 may have an associated entry counter and exit counter. For example, core 104 has an associated entry counter 136A and exit counter 138A, core 106 has an associated entry counter 136B and exit counter 138B, core 108 has an associated entry counter 136C and exit counter 138C, and core 110 has an associated entry counter 136D and exit counter 138D.

In some embodiments, after detecting a crash (e.g., a timeout), undervoltage detection module 132 uses the entry and exit counters associated with the cores to determine whether any of the cores of multi-core processing unit 102 was undervolted. In an example, undervoltage detection module 132 performs these actions for one or more of the cores indicated as being in the powered-up state via power state register 116. In an example, power state register 116 indicates that core 104 is in the powered-up state. When core 104 enters the powered-up state from the powered-down state, core 104 initiates execution of a code section. In an example, the code section is warm boot code section 133, which may be a trusted section of code that is executed frequently and includes a couple of instructions. After entering the powered-up state, core 104 may modify the value of associated entry counter 136A to indicate that core 104 has initiated execution of warm boot code section 133. In an example, the first instruction in warm boot code section 133 is to modify the value of the entry counter associated with the core executing warm boot code section 133, where the value of the entry counter is an indication that the core has initiated execution of warm boot code section 133. Core 104 may continue to execute the instructions in warm boot code section 133.

After core 104 completes execution of warm boot code section 133, core 104 modifies the value of associated exit counter 138A to indicate completion of the execution of warm boot code section 133 and hands off control to an operating system 114 that is executable in computing device 101. In an example, the last instruction in warm boot code section 133 is to modify the value of the exit counter associated with the core that is executing warm boot code section 133, where the value of the exit counter is an indication that the core has completed execution of warm boot code section 133.

Undervoltage detection module 132 may use the entry and exit counters associated with a core to determine whether the core died while executing warm boot code section 133. If a core dies before it finishes execution of warm boot code section 133, it may be likely that the core was undervolted. In an example, core 104 modifies the value of entry counter 136A by incrementing it by N, and modifies the value of exit counter 138A by incrementing it by N, where N is any positive or negative number. If N is a negative number, then core 104 effectively modifies the value of entry counter 136A by decrementing it by the absolute value of N, and modifies the value of exit counter 138A by decrementing it by the absolute value of N. It should be understood that any mathematical operation may be applied to entry counter and exit counter as long as they are modified in the same way and the values of the entry and exit counters are different when the core has not yet completed execution of warm boot code section 133. For example, core 104 may modify the value of entry counter 136A by multiplying it by 2, and may similarly modify the value of exit counter 138A by multiplying it by 2.

### B. Analyze the Crash to Determine Whether a Core was Undervolted

### I. Core Determined to Not Be Undervolted

Undervoltage detection module 132 may compare a value of entry counter 136A and a value of exit counter 138B to determine whether core 104 died while executing warm boot code section 133. In particular, if the value of entry counter 136A and the value of exit counter 138A are the same, then core 104 completed execution of warm boot code section 133 and did not die while executing it. As such, it is unlikely that core 104 was undervolted.

In response to determining that the value of entry counter 136A and the value of exit counter 138A are the same, undervoltage detection module 132 may determine that core 104 was not undervolted. In this example, the core may have crashed for a different reason. For example, power manager 120 or power supply 130 may be damaged but the crash of core 104 is not associated with the core waking up and entering the powered-up state from the powered-down state.

Undervoltage detection module 132 may continue to compare the entry and exit counters for one or more of the other cores of multi-core processing unit 102 (e.g., core 106, core 108, and/or core 110) indicated as being in the powered-up state via power state register 116.

### 2. Core Determined to be Undervolted

In contrast, if the value of entry counter 136A and the value of exit counter 138A are not the same, then core 104 has initiated execution of warm boot code section 133 and died while executing it. In particular, core 104 crashed somewhere while executing the instructions within warm boot code section 133. As such, it may be likely that core 104 was undervolted.

In response to determining that the value of entry counter 136A and the value of exit counter 138A are not the same, undervoltage detection module 132 may determine whether a power resource supplied to core 104 satisfies a power resource threshold for the core. For example, undervoltage detection module 132 may read a hardware register associated with core 104 to determine the power resource supplied to core 104 while it was in the powered-up state. In response to determining that the power resource supplied to core 104 does not satisfy the power resource threshold for the core, undervoltage detection module 132 may determine that the core was undervolted. In some embodiments, undervoltage detection module 132 sends a request to power manager 120 to reset core 104 and to provide core 104 with at least the power resource threshold for the core.

In contrast, in response to determining that the power resource supplied to core 104 satisfies the power resource threshold for the core, undervoltage detection module 132 may determine that the core was not undervolted. Undervoltage detection module 132 may continue to compare the entry and exit counters for one or more of the other cores of multi-core processing unit 102 (e.g., core 106, core 108, and/or core 110) indicated as being in the powered-up state via power state register 116.

In an example, the power resource is voltage. In this example, undervoltage detection module 132 may read voltage register 124A associated with core 104 to determine the voltage supplied to core 104. To determine whether core 104 was undervolted, undervoltage detection module 132 may determine whether the voltage supplied to core 104 satisfies the voltage threshold for the core. In an example, the voltage supplied to core 104 satisfies its voltage threshold when the supplied voltage is not less than the voltage threshold for the core. In response to determining that the voltage supplied to core 104 satisfies the voltage threshold for core 104, undervoltage detection module 132 may determine that the core was not undervolted. In contrast, in response to determining that the voltage supplied to core 104 does not satisfy the voltage threshold for core 104, undervoltage detection module 132 may determine that the core was undervolted. In some embodiments, in response to determining that the core was undervolted, undervoltage detection module 132 sends a request to power manager 120 to reset core 104 and to provide core 104 with at least the voltage threshold for the core.

Undervoltage detection module 132 may also determine the state of the other cores of multi-core processing unit 102 in relation to the voltage supplied to multi-core processing unit 102. For example, undervoltage detection module 132 may determine how much total voltage power manager 120 is supplying to multi-core processing unit 102 and whether the total supplied voltage satisfies the voltage threshold for the total number of cores that are in the powered-up state. For example, the voltage threshold for each core may be 3 Volts and if cores 106, 108, and 110 are in the powered-up state and core 104 is in the powered-down state, multi-core processing unit 102 may supply at least 9 Volts to multi-core processing unit 102 for these cores to function correctly. If core 104 enters the powered-up state from the powered-down state and power manager 120 does not supply more voltage to multi-core processing unit 102, core 104 may crash or misbehave. In an example, if all four cores are in the powered-up state, undervoltage detection module 132 may compare the currently supplied 9 Volts to the 12-Volt voltage threshold and determine that power manager 120 is not supplying enough voltage to multi-core processing unit 102.

In another example, the power resource is current. In this example, undervoltage detection module 132 may read current register 126A associated with core 104 to determine the current supplied to core 104. To determine whether core 104 was undervolted, undervoltage detection module 132 may determine whether the current supplied to core 104 satisfies the current threshold for the core. In an example, the current supplied to core 104 satisfies its current threshold when the supplied current is not less than the current threshold for the core. In response to determining that the current supplied to core 104 satisfies the current threshold for core 104, undervoltage detection module 132 may determine that the core was not undervolted. In contrast, in response to determining that the current supplied to core 104 does not satisfy the current threshold for core 104, undervoltage detection module 132 may determine that the core was undervolted. In some embodiments, undervoltage detection module 132 sends a request to power manager 120 to reset core 104 and to provide core 104 with at least the current threshold for the core.

Undervoltage detection module 132 may also determine the state of the other cores of multi-core processing unit 102 in relation to the current supplied to multi-core processing unit 102. For example, undervoltage detection module 132 may determine how much total current power manager 120 is supplying to multi-core processing unit 102 and whether the total supplied current satisfies the current threshold for the total number of cores that are in the powered-up state. For example, the current threshold for each core may be 10 mA and if cores 106, 108, and 110 are in the powered-up state and core 104 is in the powered-down state, multi-core processing unit 102 may supply 30 mA to multi-core processing unit 102. If core 104 enters the powered-up state from the powered-down state and power manager 120 does not supply more current to multi-core processing unit 102, core 104 may crash or misbehave. In an example, if all four cores are in the powered-up state, undervoltage detection module 132 may compare the currently supplied 30 mA to the 40-mA current threshold and determine that power manager 120 is not supplying enough current to multi-core processing unit 102.

### C. Analyze Reason for Core Entering Powered-Up State

### 1. Determine Whether Spurious Interrupt Occurred

Undervoltage detection module 132 may determine whether it was expected that a core entered the powered-up state and the reason for the core entering the powered-up state from the powered-down state. Memory 130 includes a set of flags 140A-140D, and each given core of multi-core processing unit 102 may have an associated flag in set of flags 140A-140D that indicates whether another core intended to bring that given core online. In an example, flag 140A is associated with core 104, flag 140B is associated with core 106, flag 140C is associated with core 108, and flag 140D is associated with core 110.

Undervoltage detection module 132 may read a flag associated with a core to determine whether the interrupt sent to the core was a spurious interrupt. In an example, if core 106 intends to bring core 104 online, core 106 may modify the value of flag 140A associated with core 104 by, for example, setting the value of the flag to zero. In this example, the default value for flag 140A may be one and may indicate that no core has intended to send core 104 an interrupt that causes core 104 to enter the powered-up state. Core 104 may modify the value of associated flag 140A after it has executed warm boot code section 133 by, for example, setting the flag to one. In some embodiments, flag 140A is set to 1 just prior to sending an intentional interrupt to a core that is in the powered-down state, and set back to 0 just before intentionally powering down the core again. According, if a core is powered on and flag 140A is not set to 1, undervoltage detection module 132 may determine that the core woke up due to a spurious (unintentional) event. For example, if undervoltage detection module 132 reads flag 140A at a later point in time and flag 140A is set to zero, undervoltage detection module 132 may determine that core 104 entered the powered-up state expectedly. In this example, a spurious interrupt did not occur. If, however, undervoltage detection module 132 reads flag 140A and it is set to one, undervoltage detection module 132 may determine that core 104 entered the powered-up state unexpectedly. In this example, a spurious interrupt has occurred.

### 2. Reason for Interrupt

Multi-core processing unit 102 includes interrupt pending registers 112A-112D. Each core of multi-core processing unit 102 may have an associated interrupt pending register that indicates the particular interrupt that was sent to the core. Each interrupt that is sent to a core has an associated number that indicates the particular interrupt sent to the core. Undervoltage detection module 132 may read an interrupt pending register associated with a core that entered the powered-up state from the powered-down state to determine the reason (e.g., the particular interrupt) for which the core entered the powered-up state.

In an example, core 106 may send an interrupt to core 104, where the interrupt is associated with the number “3.” In this example, core 106 may store the number “3” in interrupt pending register 112A, which is associated with core 104. If undervoltage detection module 132 reads interrupt pending register 112A, undervoltage detection module 132 may be able to determine which interrupt was sent to core 104 and caused it to enter the powered-up state. By knowing what caused the spurious interrupt, an administrator of the system may more easily debug this issue and fix the software code or hardware to avoid this particular spurious interrupt from happening again.

As discussed above and further emphasized here, FIG. 1 is merely an example, which should not unduly limit the scope of the claims.

### IV. Example System Architectures

For example, in FIG. 1, although undervoltage detection module 132 is illustrated as residing in and executable on computing device 101, this is not intended to be limiting and undervoltage detection module 132 may reside in and execute on a computing device that is different from computing device 101.

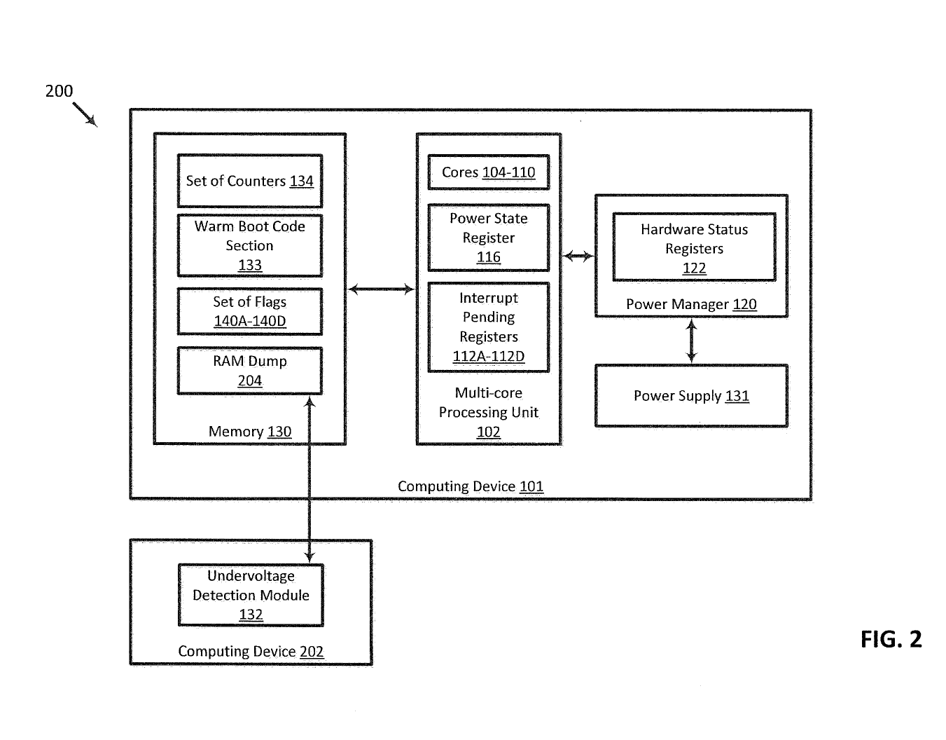

For example, FIG. 2 is a block diagram illustrating a system 200 for detecting undervolting of one or more cores of multi-core processing unit 102, according to some embodiments. In FIG. 2 undervoltage detection module 132 resides in a computing device 202 that is different from computing device 101. In some embodiments, warm boot code section 133 includes instructions to log the parameters of the voltage and current supplied to a core, flags and counters associated with the core, and interrupt information discussed above into a RAM dump 204 in memory 130.

A copy of the core's memory may be dumped into RAM dump 204 and analyzed at a later point in time. In an example, undervoltage detection module 132 may read the value of the entry and exit counters from RAM dump 204 to determine whether a core associated with those entry and exit counters died during execution of warm boot code section 133. Undervoltage detection module 132 may also read the power source (e.g., voltage or current) supplied to the core from RAM dump 204 to determine whether the power source supplied to the core satisfies a power resource threshold for the core.

Further, an administrator may perform post-processing of RAM dump 204 and read these values (e.g., entry and exit counters, flag, and registers associated with a core) to better analyze whether a core was undervolted and the cause.

Additionally, set of counters 134 is illustrated as including two counters for each core (an entry counter and exit counter for each core) and undervoltage detection module 132 has been described as comparing the values of these two different counters to determine whether the core associated with these counters died during execution of warm boot code section 133. Undervoltage detection module 132 may use other techniques to determine whether the core associated with a counter has died during execution of warm boot code section 133.

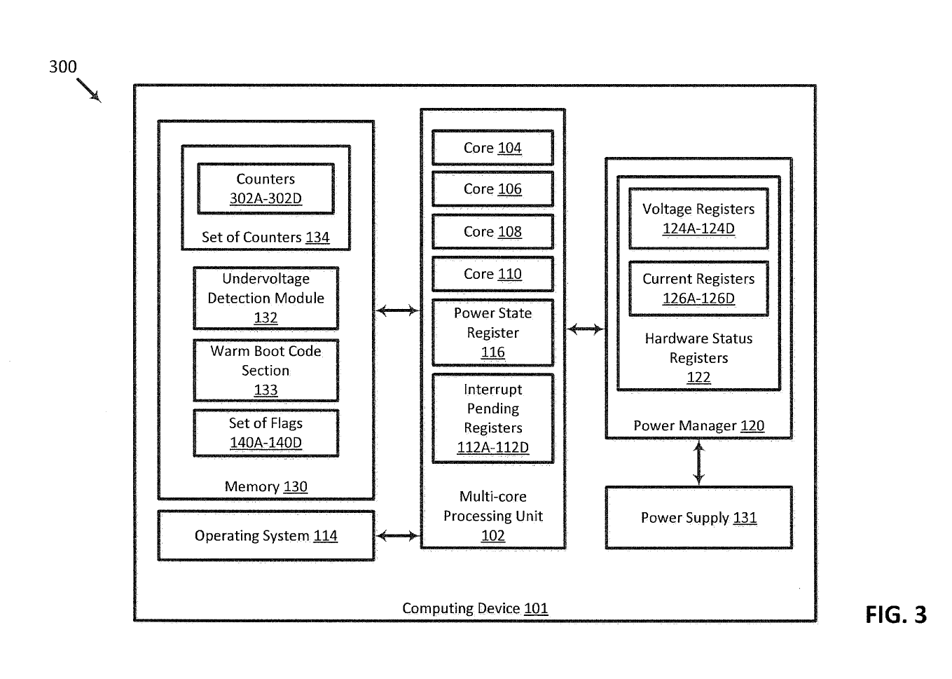

For example, FIG. 3 is a block diagram illustrating a system 300 for detecting undervolting of one or more cores of multi-core processing unit 102, according to some embodiments. In FIG. 3, set of counters 134 includes counters 302A-302D. For example, core 104 has an associated counter 302A, core 106 has an associated counter 302B, core 108 has an associated counter 302C, and core 110 has an associated counter 302D. In this example, after entering the powered-up state, core 104 may modify the value of counter 302A to indicate that core 104 has initiated execution of warm boot code section 133 and continue to execute the instructions in warm boot code section 133. After core 104 completes execution of warm boot code section 133, core 104 modifies the value of counter 302A to indicate completion of the execution of war boot code section 133 and then hands off control to operating system 114.

In some embodiments, to indicate that core 104 has initiated execution warm boot code section 133, core 104 modifies the value of counter 302A by performing an operation on counter 302A (e.g., add N to counter 302A, where N is a number), and to indicate that core 104 has completed execution of warm boot code section 133, core 104 modifies the value of counter 302A by performing a reverse operation on counter 302A (e.g., subtract N from counter 302A). Undervoltage detection module 132 may expect the value of counter 302A to be a first value if core 104 has begun executing warm boot code section 133 and may expect the value of counter 302A to be a second value if core 104 has completed execution of warm boot code section 133. In this example, in response to determining that the value of counter 302A is the first value, undervoltage detection module 132 may determine that core 104 died while executing warm boot code section 133. Likewise, in response to determining that the value of counter 302A is the second value, undervoltage detection module 132 may determine that core 104 did not die while executing warm boot code section 133.

### V. Example Methods

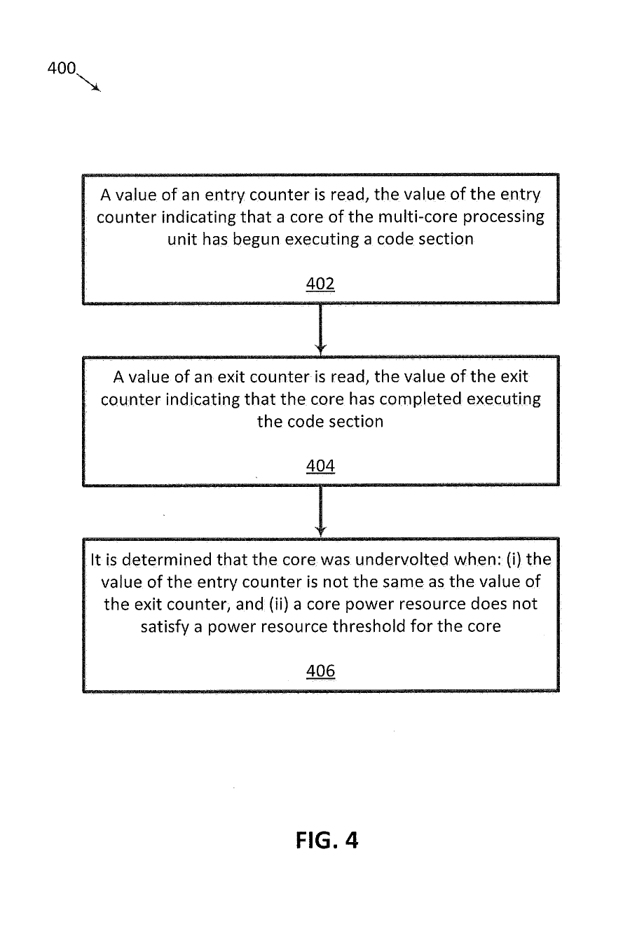

FIG. 4 is a simplified flowchart illustrating a method 400 of detecting undervolting of one or more cores of a multi-core processing unit, according to some embodiments. Method 400 is not meant to be limiting and may be used in other applications.

Method 400 includes actions 402, 404, and 406. In an action 402, a value of an entry counter is read, the value of the entry counter indicating that a core of the multi-core processing unit has begun executing a code section. In an example, undervoltage detection module 132 reads a value of entry counter 136A, the value of entry counter 136A indicating that core 104 of the multi-core processing unit 102 has begun executing warm boot code section 133.

In an action 404, a value of an exit counter is read, the value of the exit counter indicating that the core has completed executing the code section. In an example, undervoltage detection module 132 reads a value of exit counter 138A, the value of exit counter 138A indicating that core 104 has completed executing warm boot code section 133.

In an action 406, it is determined that the core was undervolted when: (i) the value of the entry counter is not the same as the value of the exit counter, and (ii) a core power resource does not satisfy a power resource threshold for the core. In an example, undervoltage detection module 132 determines that core 104 was undervolted when: (i) the value of entry counter 136A is not the same as the value of exit counter 138A, and (ii) a core power resource does not satisfy a power resource threshold for core 104.

In an embodiment, actions 402-406 may be performed for any number of cores of multi-core processing unit 102. It is also understood that additional actions may be performed before, during, or after the actions discussed above. For example, method 400 may include an action of reading a voltage register or current register. It is also understood that one or more of the actions of method 400 described herein may be omitted, combined, or performed in a different sequence as desired. For example, action 404 may be performed before action 402.

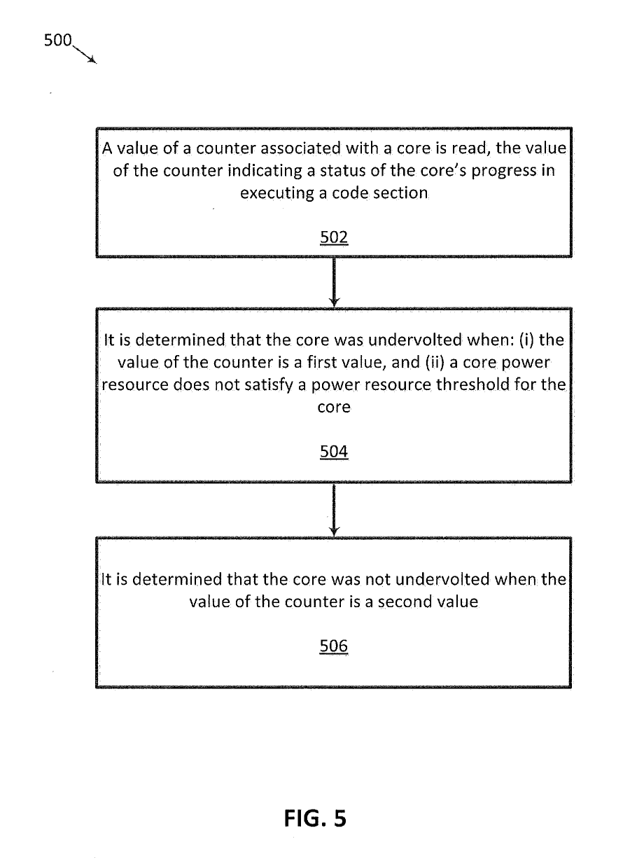

FIG. 5 is a simplified flowchart illustrating a method 500 of detecting undervolting of one or more cores of a multi-core processing unit, according to some embodiments. Method 500 is not meant to be limiting and may be used in other applications.

Method 500 includes actions 502, 504, and 506. In an action 502, a value of a counter associated with a core is read, the value of the counter indicating a status of the core's progress in executing a code section. In an example, undervoltage detection module 132 reads a value of counter 302A associated with core 104, the value of counter 302A indicating a status of core 104's progress in executing warm boot code section 133.

In an action 504, it is determined that the core was undervolted when: (i) the value of the counter is a first value, and (ii) a core power resource does not satisfy a power resource threshold for the core. In an example, undervoltage detection module 132 determines that core 104 was undervolted when: (i) the value of counter 302A is a first value, and (ii) a core power resource does not satisfy a power resource threshold for core 104.

In an action 506, it is determined that the core was not undervolted when the value of the counter is a second value. In an example, undervoltage detection module 132 determines that core 104 was not undervolted when the value of counter 302A is a second value.

In an embodiment, actions 502, 504, and 506 may be performed for any number of cores of multi-core processing unit 102. It is also understood that additional actions may be performed before, during, or after the actions discussed above. For example, method 500 may include an action of reading a voltage register or current register. It is also understood that one or more of the actions of method 500 described herein may be omitted, combined, or performed in a different sequence as desired.

### VI. Example Computing Device

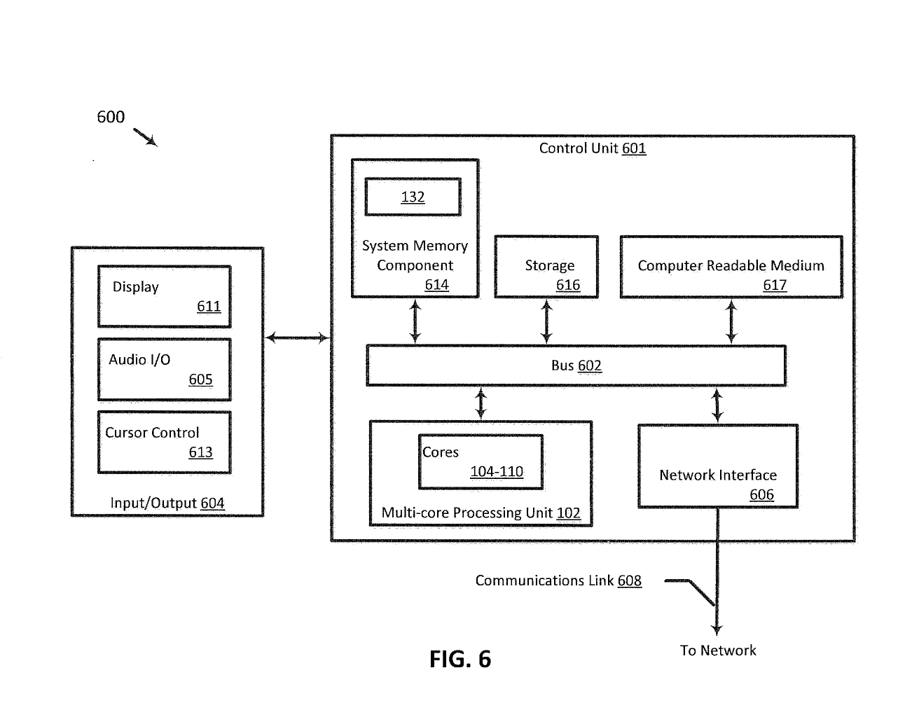

FIG. 6 is a block diagram of an example computer system 600 suitable for implementing any of the embodiments disclosed herein. In various implementations, computer system 600 may be computing device 101. The computer system 600 may include one or more processors. The computer system 600 may additionally include one or more storage devices each selected from a group including floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to a client or server using a computer network (not shown). The computer network may be any type of network including a LAN, a WAN, an intranet, the Internet, a cloud, and/or any combination of networks thereof that is capable of interconnecting computing devices and/or computer programs in the system.

Computer system 600 includes a bus 602 or other communication mechanism for communicating information data, signals, and information between various components of computer system 600. Components include an input/output (I/O) component 604 for processing user actions, such as selecting keys from a keypad/keyboard or selecting one or more buttons or links, etc., and send a corresponding signal to bus 602. I/O component 604 may also include an output component such as a display 611, and an input control such as a cursor control 613 (such as a keyboard, keypad, mouse, etc.).

An audio I/O component 605 may also be included to allow a user to use voice for inputting information by converting audio signals into information signals. Audio I/O component 605 may allow the user to hear audio. A transceiver or network interface 606 transmits and receives signals between computer system 600 and other devices via a communication link 618 to a network. In an embodiment, the transmission is wireless, although other transmission mediums and methods may also be suitable. One or more processors in multi-core processing unit 102, which may be a micro-controller, digital signal processor (DSP), or other processing component, processes these various signals, such as for display on display 611 of computer system 600 or transmission to other devices via communication link 618. System memory component 614 may include undervoltage detection module 132, which may execute on one or more cores of multi-core processing unit 102 or on one or more cores on another system. A processor may also control transmission of information, such as cookies or IP addresses, to other devices.

Components of computer system 600 also include a system memory component 614 (e.g., memory 130 and/or RAM), a static storage component 616 (e.g., ROM), and/or a computer readable medium 617. Computer system 600 performs specific operations by one or more processing cores of multi-core processing unit 102 and other components by executing one or more sequences of instructions contained in system memory component 614. Logic may be encoded in computer readable medium 617, which may refer to any medium that participates in providing instructions to one or more processing cores of multi-core processing unit 102 for execution. Such a medium may take many forms, including but not limited to, non-volatile media, volatile media, and transmission media. In various implementations, non-volatile media include optical, or magnetic disks, or solid-state drives, volatile media include dynamic memory, such as system memory component 614, and transmission media include coaxial cables, copper wire, and fiber optics, including wires that include bus 602. In an embodiment, the logic is encoded in non-transitory computer readable medium. Computer readable medium 617 may be any apparatus that can contain, store, communicate, propagate, or transport instructions that are used by or in connection with one or more processing cores of multi-core processing unit 102. Computer readable medium 617 may be an electronic, magnetic, optical, electromagnetic, infrared, or semiconductor device or a propagation medium, or any other memory chip or cartridge, or any other medium from which a computer is adapted to read. In an example, transmission media may take the form of acoustic or light waves, such as those generated during radio wave, optical, and infrared data communications.

In various embodiments of the present disclosure, execution of instruction sequences (e.g., method 400 and/or method 500) to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various actions described herein may be changed, combined into composite actions, and/or separated into sub-actions to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A method of detecting undervolting of one or more cores of a multi-core processing unit, comprising:
reading a value of an entry counter and a value of an exit counter, the value of the entry counter indicating that a core of the multi-core processing unit has begun executing a code section, and the value of the exit counter indicating that the core has completed executing the code section; and
determining that the core was undervolted when: (i) the value of the entry counter is not the same as the value of the exit counter, and (ii) a core power resource does not satisfy a power resource threshold for the core.

2. The method of claim 1, further comprising:
entering, at the core of the multi-core processing unit, a first power state from a second power state;
incrementing the value of the entry counter; and
after executing the code section, incrementing the value of the exit counter.

3. The method of claim 2, wherein incrementing the value of the entry counter includes incrementing by N, and incrementing the value of the exit counter includes incrementing by N, wherein N is a number.

4. The method of claim 2, further comprising:
determining that the core failed to fully execute the code section when the value of the entry counter and the value of the exit counter are not the same.

5. The method of claim 4, further comprising:
determining that the core completed executing the code section when the value of the entry counter and the value of the exit counter are the same.

6. The method of claim 2, wherein entering the first power state is in response to receiving an interrupt, the method further comprising:
reading a flag associated with the core to determine whether the interrupt is a spurious interrupt; and
reading an interrupt pending register associated with the core to determine a reason for which the core entered the first power state.

7. The method of claim 1, wherein the power resource threshold is not satisfied when a voltage supplied to the core is less than a voltage threshold for the core.

8. The method of claim 1, wherein the power resource threshold is not satisfied when a current supplied to the core is less than a current threshold for the core.

9. The method of claim 1, further comprising:
when the core was undervolted, sending a request to a power manager to reset the core and to supply the power resource to the reset core.

10. The method of claim 1, further comprising:
reading the value of the entry counter, the value of the exit counter, and the core power resource from a RAM dump.

11. The method of claim 1, wherein the reading is in response to detecting a timeout of the core.

12. A system for detecting undervolting of one or more cores of a multi-core processing unit, comprising:
a multi-core processing unit including a plurality of cores, wherein a core executes one or more instructions and has an associated entry counter and exit counter; and
an undervoltage detection module that reads a value of an entry counter and a value of an exit counter and determines that the core was undervolted when: (i) the value of the entry counter is not the same as the value of the exit counter, and (ii) a core power resource does not satisfy a power resource threshold for the core,
wherein the value of the entry counter indicates that a core of the multi-core processing unit has begun executing a code section, and the value of the exit counter indicates that the core has completed executing the code section.

13. The system of claim 12, wherein the code section is a warm boot code section.

14. The system of claim 12, wherein the multi-core processing unit resides in a first computing device and the undervoltage detection module executes in a second computing device different from the first computing device.

15. The system of claim 12, wherein the core enters a first power state from a second power state, increments the value of the entry counter, and increments the value of the exit counter after executing the code section.

16. The system of claim 15, wherein the core increments the value of the entry counter by N and increments the value of the exit counter by N, wherein N is a number.

17. The system of claim 15, wherein the undervoltage detection module determines that the core failed to fully execute the code section when the value of the entry counter and the value of the exit counter are not the same.

18. The system of claim 15, wherein the undervoltage detection module determines that the core completed executing the code section when the value of the entry counter and the value of the exit counter are the same.

19. The system of claim 12, wherein the power resource is voltage or current.

20. A computer-readable medium having stored thereon computer-executable instructions for performing operations, comprising:
reading a value of an entry counter and a value of an exit counter, the value of the entry counter indicating that a core of the multi-core processing unit has begun executing a code section, and the value of the exit counter indicating that the core has completed executing the code section; and
determining that the core was undervolted when: (i) the value of the entry counter is not the same as the value of the exit counter, and (ii) a core power resource does not satisfy a power resource threshold for the core.
